(19) United States
(12) Patent Application Publication
(10) Pub. No.: US 2002/0021220 A1
(43) Pub. Date: Feb. 21, 2002

(54) Method and apparatus for toilet training and related wetness sensing material

(76) Inventor: Nina Mary Claire Dreyer, Dana Point, CA (US)

Correspondence Address: William J. Brucker, Esq., STETINA BRUNDA GARRED & BRUCKER, 75 Enterprise, Suite 250, Aliso Viejo, CA, 92656, US

(21) Appl. No.: 09/925,852

(22) Filed: Aug. 9, 2001

Related U.S. Application Data
(60) Provisional application No. 60/224,542, filed on Aug. 11, 2000.

(51) Int. Cl. G08B 23/00

(52) U.S. Cl. 340/573.1; 340/540

(57) ABSTRACT

A method and apparatus for training a child in the use of toilets by means of operant conditioning is provided. In the first phase of the method, the child is put in diapers configured to produce a selected stimulus when wet or soiled. Over time, the child comes to associate the stimulus with urination. In the second phase of the method, the child is provided with a child toilet configured to produce the same stimulus as the diapers of the first phase when sat upon by the child. The child encounters the familiar urination stimulus each time he/she sits on the toilet, and thus comes to associate the toilet with urination.

### CROSS-REFERENCE TO RELATED APPLICATIONS

This patent application claims priority to U.S. Provisional Application Ser. No. 60/224,542 entitled AUDIBLE TRAINING DIAPER filed on Aug. 11, 2000, incorporated herein by reference.

### STATEMENT RE: FEDERALLY SPONSORED RESEARCH/DEVELOPMENT

(Not Applicable)

### BACKGROUND OF THE INVENTION

The present invention relates generally to child development, and more particularly to a method and apparatus for training young children to use toilets involving operant conditioning.

A common problem associated with child development is the difficulty of training a child in the use of toilets. Young children naturally urinate whenever and wherever they feel the need to do so, and must be kept in diapers until they learn to use toilets. Accordingly, it is desirable to train young children in the use of toilets as early as possible. Psychological research has demonstrated that child learning is achieved most effectively by repetition. However, it is highly inconvenient for a parent to constantly monitor a child and take the child to the toilet each time the child urinates. As a result, various toilet training devices designed to encourage children to use the toilet have come into use.

Prior art toilet training devices include child toilets or potties. Child toilets are small compared to normal toilets and are self contained, so that they may be placed within the child's room. The child toilet may be painted in bright colors or otherwise designed to appeal to the child. Hopefully, the proximity and attractiveness of the toilet make it more likely that the child will experiment with it and grow to use it.

A deficiency with existing child toilets relates to the lack of association by the child between urination and use of the child toilet. The association must be learned, typically through the repetitious encouragement from child's parent. Unless the parent continually reminds the child that he/she should use the toilet for urination, the child may not develop the desired behavior with satisfactory rapidity.

Prior art toilet training devices also include child toilets which are designed to reward the child for using the toilet. These toilets reward the child by playing a musical tune or otherwise responding in an entertaining fashion when the child uses them. Typically, a pressure plate impacted by the child's weight upon the seat activates the reward system. One such child toilet is disclosed by U.S. Pat. No. 5,781,939 POTTY TRAINING CHAIR WITH CHILD RESTRAINT, ACTIVITY AREA AND AUDIBLE REWARD SYSTEM issued to Bledsoe and incorporated herein by reference. This type of child toilet has the advantage of not only attracting the child to the toilet, but specifically attracting the child to sit on the toilet. Thus, this child toilet gets the child one step closer to the desired objective of urinating in the toilet.

Child toilets employing a reward system still fail to provide specific means to associate the toilet with urination in the child's mind. The child can activate the reward system without actually urinating, and may regard the child toilet as nothing more than an entertainment device. None of the prior art devices provide a stimulus or reward that compels the child to specifically seek out the toilet each time he/she needed to urinate. Also, the prior art devices start the training at a later stage such that the child can only begin learning once he/she has reached an age at which he/she is physically capable of using the toilet.

It would therefore be desirable to provide a child toilet which produces a stimulus the child already associates with urination. Further, it would be desirable to start that association at an earlier age. The effectiveness of the training toilet should thereby be substantially increased.

The present invention contemplates use of a urination stimulus associated with a diaper. Diapers which produce an alarm when soiled are exemplified, for instance, by U.S. Pat. No. 54,768,023 DIAPER WETNESS SIGNALLING [sic] SYSTEM issued to Xie; No. U.S. Pat. No. 5,264,830 APPARATUS FOR SENSING WET DIAPER issued to Kline et al.; and U.S. Pat. No. 5,838,240 WET DIAPER DETECTOR issued to Johnson, all of which are incorporated herein by reference. Although prior art diaper wetness alarms are configured to produce a beeping sound, light, or other stimulus, they are not ideal for the purposes of the present invention to produce a pleasant association between the urination event and the child toilet.

A related problem exists involving disposable diapers or undergarments incorporating electronics. Devices of this type require electrical power provided by a battery and are bulky and cost prohibitive. Batteries dissipate over time and require replacement, causing inconvenience for the user. As users of electronic products will be aware, the inconvenience caused by having to find replacement batteries is undesirable, and may lead to non-use of the product. Also, the discomfort associated with a battery and electronic system is not desirable particularly when comfort for a baby or toddler is paramount.

Also, it is desirable that the disposable undergarment be changed each time it is soiled. In order to accomplish this with the prior art, the user would either have to discard the batteries and the associated electronics, which is wasteful, or otherwise import the same batteries and electronics to each new disposable garment, which is unsanitary and cumbersome. Also, including a traditional battery on each new undergarment would be cost prohibitive. Also, the environmental implications of discarding traditional batteries on a regular basis, each of which contains environmentally unsafe chemicals, are unacceptable.

It would therefore be desirable to provide a disposable undergarment integrally incorporating a battery and associated electronics free of the above mentioned drawbacks.

### BRIEF SUMMARY OF THE INVENTION

In accordance with the present invention there is provided a method and apparatus for training a child in the use of toilets by means of operant conditioning.

The method takes place in two phases. In the first phase, operant conditioning is used to form an association in the child's mind between urination and a selected stimulus. The association is formed by placing the child in diapers which include an alarm system configured to produce the stimulus when the child wets or soils the diapers. The stimulus is encountered each time the child wets or soils a new diaper, and thus the child will eventually form an association between the urination and the selected stimulus. The selected stimulus may be a pleasant musical tune, voice, or other sound.

The diapers of the present invention have an alarm system integrally formed on each disposable diaper. The diapers incorporate a light weight, cost effective power system and associated electronics.

In the second phase of the method of the present invention, the association formed in the first phase is used to create an understanding in the child's mind that the toilet is the appropriate place to urinate. Specifically, the child is provided with a child toilet configured to produce the same selected stimulus when sat upon by the child. When the child encounters the stimulus, the association will be triggered and he/she will think of urination. Thus, he/she will come to understand that the toilet is associated with urination.

### BRIEF DESCRIPTION OF THE DRAWINGS

These as well as other features of the present invention will become more apparent upon reference to the drawings wherein:

FIG. 1 illustrates the first phase of the method of the present invention, involving creating an association in the child's mind between a selected stimulus and urination by means of operant conditioning.

FIG. 2 illustrates the second phase of the method of the present invention, involving creating an association in the child's mind between the toilet and urination through the use the association formed in the first phase.

FIG. 3 illustrates a disposable diaper designed in accordance with the apparatus of the present invention, having an alarm system powered by a flexible dry battery disposed on the disposable diaper.

### DETAILED DESCRIPTION OF THE INVENTION

The detailed description as set forth below in connection with the appended drawings is intended as a description of the presently preferred embodiments of the present intention, and does not represent the only embodiment of the present invention. It is understood that various modifications to the invention may be comprised by different embodiments and are also encompassed within the spirit and scope of the present invention.

The method of the present invention relies generally upon the psychological principles of operant conditioning as known to those in the art. In operant conditioning, a subject learns to repeat a desired behavior in order to produce an expected reward. Each time the desired behavior is repeated by the subject, the reward is produced. Over time, the subject becomes aware of the cause/effect relationship between the behavior and the reward, and learns to repeat the behavior in order to produce the reward.

The method of the present invention is founded upon the basic laws of learning theory, which exploits the relationship between stimulus and response. Conditioning is the process to which a particular response comes to be triggered by a particular stimulus ((Burger, K. S. 1998) The Developing Person Through the Lifespan, University of Nebraska, Lincoln: Worth Publishers). In operant conditioning, a baby learns that a particular behavior produces a particular consequence. If the consequences are pleasurable, the baby will repeat the behavior to produce the consequences (Burger 1998). Burger, Page 36 states “a system of pleasurable consequences might be used to train an organism to perform a specific behavior that is not in organisms natural repertoire.”

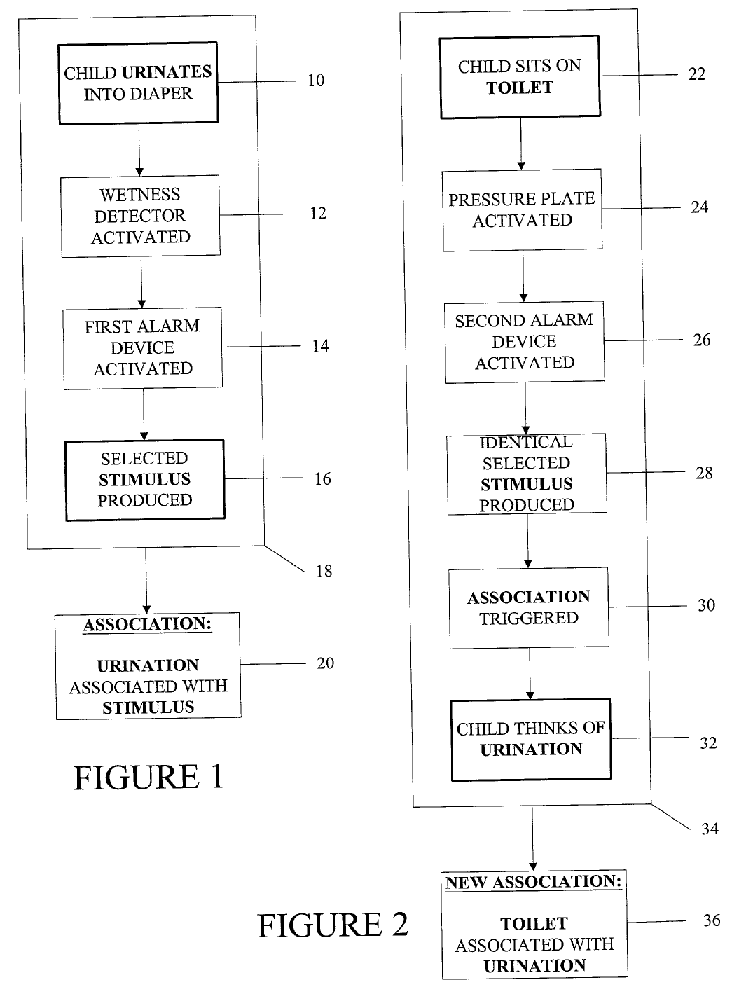

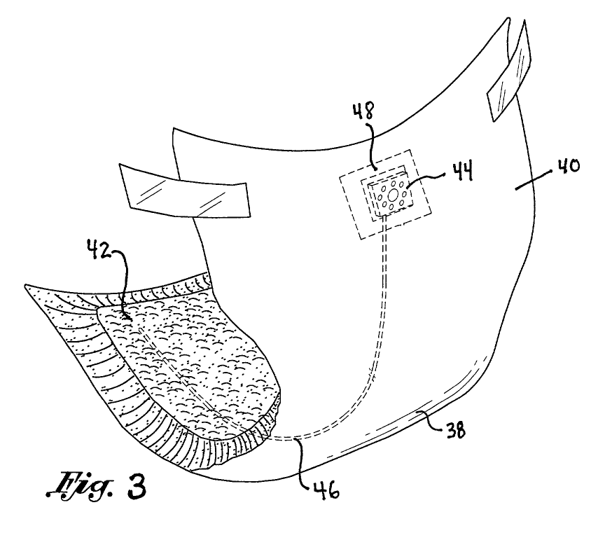

The method of the present invention takes place in two distinct phases. In the first phase (FIG. 1) of the method, an association 20 is formed between a selected stimulus and urination by means of operant conditioning 18. In the second phase (FIG. 2) of the method, the association 20 is used to form an understanding 36 in the child's mind through cause and effect 34 that the toilet is the proper place for urination.

The first phase preferably occurs when the child is approximately 6 to 12 months old, although it is understood that the method of the present invention can be introduced at any age. During this period of life, the child is at the period of cognitive development wherein the child is for the first time able to understand cause/effect relationships, and thus may be conditioned according the principles of operant conditioning. In accordance with the first phase of the method of the present invention there are employed diapers incorporating an alarm device operative to produce a selected stimulus when they are wet or soiled.

Diapers incorporating wetness alarm systems are known in the art, and may be modified to produce a selected stimulus appropriate to the purposes of the present invention. An appropriate stimulus is any stimulus that the child considers positive and would be interested in bringing about. Children in the 6-12 month stage of development are extremely interested in the world around them, and consider many stimuli positive. In the method of the present invention, the selected stimulus is a musical tune. Although the method of the present invention contemplates use of a musical tune, it is additionally contemplated by the present invention that the produced stimulus may be any pleasurable audible sound, including a beep, tone or a recording of the mother's voice. In addition, the stimulus could be a vibration or some other physical non-audible stimulus.

The first phase of the method of the present invention is illustrated by FIG. 1. First, the child urinates into the diaper 10. Urination is associated with the behavior to be conditioned, and is thus the first element in the chain of cause and effect of operant conditioning 18. The diaper incorporates a wetness sensor operative to produce an electrical signal when the diaper is soiled by the child. When the child urinates 10, the wetness sensor is activated. An alarm device operative to produce a selected stimulus in response to the electrical signal of the wetness sensor is activated 14. The selected stimulus is then produced 16. The selected stimulus is the reward to which the behavior of bladder control is to be conditioned, and thus the last element in the chain of cause and effect operant conditioning 18.

The chain of cause and effect operant conditioning 18 is repeated with each new diaper. Over time, the child learns the association 20 between urination 10 and the selected stimulus 16.

In the method of the present invention, although the diaper utilized in the first phase of the method can comprise any prior art wetness detecting diaper, it is preferred that a diaper utilizing lightweight integrated electronics be utilized.

Referring particularly to FIG. 3, a novel disposable diaper is illustrated. A diaper 38 is shown. The diaper 38 includes a water impervious outer material 40 and an inner water absorbent material 42. An audible alarm device 44 is incorporated beneath the outer liner 40, so that the device 44 is not accessible or removable by the child. Although the audible alarm device 44 is preferably located beneath the outer material 40, it is contemplated by the present invention that the device 44 may be located exterior to the material 40.

The audible alarm device 44 is in electrical communication with a wetness detector 46. The wetness detector 46 senses moisture by exhibiting a change in electrical resistance when it is transitioned from its dry to wet state. The detector 46 is analogous to a two-terminal switch. When dry, the detector 46 is open and exhibits infinite resistance. When wet, the detector exhibits between 50 k to 80 k ohms. The audible alarm device 44 senses the change in resistance and causes the alarm to sound for approximately 10 to 15 seconds. Although the present invention contemplates a duration of 10 to 15 seconds, it is also contemplated by the present invention that the alarm time could be varied, but at least long enough to be sufficient to affect the operant conditioning of the child.

The audible alarm device 44 includes a speaker. Preferably the speaker would have a diameter of less than one inch, but it would be able to produce a sound audible to the child.

The diaper shown in FIG. 3 which is utilized in the method and apparatus of the present invention includes a novel smaller and thinner environmentally friendly “paper battery.” Such thin cell battery technology is available from Power Paper, Ltd., Tel Aviv, Israel. The non-rechargeable thin battery source is flexible like paper. The paper battery cell product is discussed in Electronic Products, December 2000(P. 23). The thin cell technology allows battery cells that do not require a housing in which may be incorporated into disposable products. The battery technology utilizes zinc and manganese-oxide-base cathode and anode layers fabricated from ink-like materials that can be printed, pasted or laminated into a variety of substrates including, paper, plastic and materials typically utilized in diapers. The thin cell battery is a flexible dry battery that eliminates the need for metal case, and allows the power source to be seamlessly integrated within a micro-electronic device. Because the battery cell structure has no metal case, the paper power cells are produced at much less cost than traditional batteries. The printed power cell provides 1.5 volts with the capacity of over 15 small mHh with a two (2) year shelf-life. Cells can be utilized in multiple combinations for higher voltages. All the ingredients incorporated into the thin power cell technology are safe and non-toxic. Finished cells can be integrated with printed circuits and microchips to perform various functions. For purposes of this application the thin power cell technology described herein will be referred to as a “paper power cell.”

The paper power cell technology, which is thin and flexible, is ideal for the use with respect to an audible alarm diaper system. Such power cells are comfortable and environmentally friendly, and are inexpensive to produce. Referring particularly to FIG. 3 a paper power cell 48 is included to power the audible alarm device 44.

Due to the flexible nature of the paper power cell 48, the audible alarm device with wetness detection incorporated into absorbent material, may be carried over into other applications. Audible alarm devices incorporating the thin power cell technology could be utilized in association with bandages and other medical wraps to alert health care providers of wet conditions which are concealed. It is additionally contemplated that the same technology could be utilized with respect to adult diapers and particularly useful for paraplegic or quadriplegic patients who have no sensation in lower extremities. Such an alarm would indicate to such a user that a wet condition exists when it can not be readily felt by the skin. It is also contemplated that the device would also be useful for other populations such as geriatric care, stroke victims and individuals in skilled nursing care.

Although it is contemplated by the present invention that the alarm device 44 would generate an audible sound, it is additionally contemplated by the present invention that other forms of signaling may be employed. For example, instead of generating an audible sound, the alarm device could generate a radio frequency which is detected by a radio frequency receiver. The radio frequency receiver could then generate the audible sound or other pleasant stimulus. It is also contemplated that a lead line could be connected directly to the electronic device 44 on the diaper, although this would be less desirable for mobility reasons. The lead line, however, may have application and use with medical bandages and adult diapers to alert a caregiver through an external electronic device. A signal to a nursing station that wetness exists would provide an immediate status indicator. Early indicators are helpful in addressing the wetness to avoid bed sores and complications.

The second phase of the method of the present invention takes place during the period of the child's life when he/she is approximately 12-15 months old. Although the second phase preferably occurs during the 12-15 month old stage, is contemplated by the present invention that the second stage can be introduced at any time so long as it is subsequent to the first phase. At this stage of life, the child is able to physically use a toilet.

In accordance with the second phase of the method of the present invention there is provided a child toilet configured to produce the same selected stimulus as the aforementioned diapers when sat upon by the child. Child toilets which produce a stimulus are known in the art, and may be modified to produce the selected stimulus of the aforementioned diapers.

First, the child sits on the toilet 22. The toilet is one of the elements to be in the new association, and is thus the first element in the new chain of cause and effect 34. The toilet includes a pressure plate configured to produce an electrical signal when sat upon. Thus, when the child sits on the toilet 22 he/she activates the pressure plate 24. The toilet further includes an alarm device configured to produce a selected stimulus identical to that of the first alarm device (of the diapers) in response to the electrical signal. When the pressure plate is activated 24, the second alarm device is activated 24. Thus, the identical selected stimulus is produced 28. Hearing the selected stimulus will trigger the child's association with urination 30. Thus, the child will think consciously and/or subconsciously of urination 32. The thought of urination 32 is to be associated with the first element of sitting on the toilet 22 in the chain of cause and effect 34, and is thus the last element in the chain of cause and effect 34. Thus, the child will learn a new association 36 that the toilet is associated with urination.

When the child encounters the stimulus he/she associates with urination in the context of a toilet, he/she will come to understand that the toilet is associated with urination. Thus, the child will gradually learn that the toilet is the appropriate place for urination. Note that while the first phase of the method of the present invention employs operant conditioning, the second phase uses the association formed in the first phase.

Additional modifications to the method of the present invention and the devices used in accordance with the method will be apparent to those skilled in the art. It is understood that such additional modifications are within the scope and spirit of the present invention.

1. A method for training a child in the use of toilets, the method comprising:
a) Detecting initial wetness in a diaper;
b) Generating a selected stimulus to alert a trainee that urination has taken place;
c) Repeating the first and second steps to create an association in the mind of the trainee between urination and the selected stimulus;
d) Detecting the trainee sitting upon a toilet seat;
e) Generating the selected stimulus to invoke the association of urination in the mind of the trainee; and
f) Repeating the fourth and fifth steps to create an association in the mind of the trainee between urination and sitting on the toilet seat;

2. The method for training a child in the use of toilets of claim 1, wherein the selected stimulus is a musical tune.

3. The method for training a child in the use of toilets of claim 1, wherein the selected stimulus is the recorded voice of a child's mother.

4. A system for child toilet training comprising the combination of:
a) a disposable diaper adapted to detect the presence of urine or fecal matter and to generate an audible signal comprising:
1) an outer layer of water impervious material and an inner layer of water absorbent material; and
2) An electronic signaling device disposed interior to the water impervious material having
i) an audible alarm generator;
ii) a wetness sensor in electrical communication with said alarm generator; and
iii) an onboard battery power source to provide power to the alarm generator; and
b) A toilet seat for generating an audible signal when a trainee is seated upon said toilet seat comprising:
1) a seat;
2) an audible alarm generator;
3) a pressure sensor in electrical communication with said alarm generator positioned to generate an electrical signal when trainee is seated upon the toilet seat; and
4) an onboard battery power source to provide power to the alarm generator.

5. The system of claim 4 wherein said battery power source of said electronic signaling device comprises a thin paper power cell.

6. The system of claim 4 wherein the audible alarm device is removably coupled to the diaper.

7. A garment for the detecting and signaling of wetness comprising:
a) Flexible wearable material having an inner and outer surface, said inner surface adjacent the skin of a wearer of the material;
b) An electronic signaling device disposed on said material;
c) A wetness sensor disposed in electrical communication with the electronic signaling device and positioned on said material; and
d) A battery power source comprising a thin paper power cell.

8. The garment of claim 7 wherein said flexible wearable material is a diaper.

9. The garment of claim 7 wherein said flexible wearable material is a bandage.

10. The garment of claim 7 wherein said electronic signaling device is an audible alarm.

11. The garment of claim 7 wherein said electronic signaling device is a radio transmitter.

12. The garment of claim 7 wherein said electronic signaling device is in electrical communication with an external signal receiver.

13. The garment of claim 7 wherein said electronic signaling device is removably coupled to said material.

14. The garment of claim 7 wherein said wetness sensor is positioned between the material and the skin of the wearer of the material.

15. The garment of claim 7 wherein said wetness sensor is embedded within the material.
